(19) United States
(12) Patent Application Publication
(10) Pub. No.: US 2011/0017340 A1
(43) Pub. Date: Jan. 27, 2011

(54) Syntactic Foam Compositions, Pipelines Insulated with Same, and Method

(75) Inventors: Thomas C. Mirossay, Arlington, TX (US); William J. Benton, Magnolia, TX (US)

Correspondence Address: Cabot Corporation/FinchMaloney, Cabot Corporation, Law Department, 157 Concord Road, Billerica, MA, 01821, US

(73) Assignee: CABOT CORPORATION, Boston, MA (US)

(21) Appl. No.: 12/747,287

(22) PCT Filed: Dec. 18, 2008
(86) PCT No.: PCT/US08/13864

§ 371 Date: Sep. 22, 2010

Related U.S. Application Data
(60) Provisional application No. 61/008,668, filed on Dec. 21, 2007.

(51) Int. Cl. F16L 9/14; C08L 63/00

(52) U.S. Cl. 138/149; 521/178

(57) ABSTRACT

Syntactic foams and thermal insulation as described containing epoxy resin, hollow microspheres, and dried sol-gel or fumed metal oxide for forming a thermal insulating layer on a substrate such as a pipeline. Methods for forming such thermal insulating layers are also described, which can include formulating with blowing agents for forming closed cells in the finished insulating foam.

### BACKGROUND OF THE INVENTION

The present invention relates to syntactic foams, thermal insulation, and void fillers. Particularly, the present invention relates to syntactic foam compositions comprising epoxy resin, hollow microspheres, and dried sol-gel of small particle size, for forming a thermal insulating layer on a substrate such as a pipeline and/or for void filling, and methods for forming such thermal insulating layers which can include formulating with blowing agents for forming closed cells in the finished insulating foam.

Offshore oil drilling is conducted at increasing ocean and sea depths. Undersea oil pipelines convey oil from underwater wellheads to shore or other surface installations for further distribution. The offshore wellhead can be located thousands of feet below the sea or ocean surface and at great distances from the shore. Deep sea oil pipelines used to transport the oil are exposed to cold water temperatures and high hydrostatic pressure conditions. The oil extracted from deep sea underwater wells is hot. The cold water environment cools the oil passing through the pipelines. The oil can tolerate only a limited amount of cooling during transfer through a pipeline immersed in the cold seawater before it thickens up and forms slugs. The slugs can plug pipelines and reduce the flow rate of oil to the surface. Gas trapped behind a slug moves more slowly through a pipeline than it would if the passageway were clear. Pressure will tend to build behind a liquid slug to keep it moving. Hard-to-control surges of compressed gas can occur when the slug ultimately reaches the outlet of the pipeline.

Oil pipelines have been insulated in efforts to reduce cooling effects of deep sea water on the oil during transit through the pipelines and keep the oil free-flowing. The insulation needs thermal conductivity, hydrostatic pressure strength, and buoyancy properties that will allow it to be used in deep sea conditions. Polyurethane foams have been used to insulate oil pipelines. The polyurethane foams are relatively porous and tend to readily degrade in marine environments, particularly at deeper sea depths. Syntactic foam materials also have been described for the thermal insulation of offshore oil pipelines. See, e.g., V. Sauvant-Moynot et al., J Mater Sci 41 (2006) 4047-4054. As discussed therein, “syntactic foam materials” are generally based on hollow glass microspheres embedded in an organic resin matrix. Oil pipelines used for undersea oil transport can have significant diameters and lengths. Syntactic foam formulations are needed that are conducive to large scale production and deliver a myriad of performance characteristics desired in the finished insulated piping.

Curable syntactic foam compositions have been applied in a flowable condition to external pipe surfaces and hardened in place. Syntactic foam compositions, however, have been observed by the present investigators to sag after they are coated on pipe surfaces and before the formulations sufficiently set-up to become immobilized. This sagging problem can lead to uneven coating thicknesses on the pipe surfaces. Sag control is complicated because the syntactic formulation also should avoid leveling problems and allow for high rate coverage.

Accordingly, there is a need to provide a novel and improved syntactic foam composition and a method for insulating oil pipes and other substrates therewith.

All of the patents and publications mentioned throughout are incorporated in their entirety by reference herein.

### SUMMARY OF THE PRESENT INVENTION

It is therefore a feature of the present invention to provide syntactic foams, thermal insulation materials, and/or void fillers. Particularly, the present invention relates to syntactic foams for thermal insulation of substrates such as oil pipelines in cold water, high hydrostatic pressure conditions, and also relates to void fillers.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages and in accordance with the purposes of the present invention, as embodied and broadly described herein, the present invention relates to curable epoxy syntactic foam coating compositions for forming a thermal insulating material comprising curable epoxy resin, hollow microspheres, and dried sol-gel having a particle size, such as less than about 100 μm. In a further embodiment, the curable epoxy syntactic foam coating composition further comprises a blowing agent for forming closed cells in the cured foam. Cured syntactic epoxy foams made with these compositions have improved thermal insulation properties, buoyancy, controlled water uptake, and/or strength to withstand the hydrostatic pressure conditions at deep sea depths, such as in excess of several thousand feet of water, and also provide a more rheologically useful coating composition that can be coated on a pipe surface and cured in place without sagging or unduly flowing before the composition sets.

Amongst other surprising benefits and advantages, it has been discovered that the presence in a syntactic foam composition of dried sol-gel having a particle size, such as less than about 100 μm, disperse well and help bind the syntactic foam composition to provide a more coherent coating composition that adheres well and holds coating shape until it sets-up to significantly reduce or eliminate coating sagging problems without hampering the desired performance properties of the finished syntactic foam, such as when used as a thermal insulative lining for undersea pipes.

In various embodiments, the dried sol-gel comprises amorphous aerogel particles, xerogel particles, or a combination of both. The dried sol-gel has a particle size less than the wall size of the syntactic foam, and can be less than about 100 μm, particularly less than about 20 μm, more particularly less than about 10 μm. In one embodiment, the dried sol-gel has a particle size in the range from 50 nm to 10 μm.

In another embodiment, an epoxy syntactic foam composition is provided comprising hardened epoxy resin, hollow microspheres, dried sol-gel having a particle size (e.g. less than about 100 μm), and closed gas-filled cells. In one embodiment, the cured epoxy syntactic foam composition comprises at least 25 vol % closed cell content. In a further embodiment, the cured epoxy syntactic foam composition comprises 5 vol % to 7 vol % hollow microspheres; 25 vol % to 30 vol % closed cell content; 20 vol % to 31 vol wt % epoxy resin; and 0.1 vol % to 7 vol % dried sol-gel, for instance, having a particle size less than about 100 μm. In another embodiment, the cured epoxy syntactic foam composition comprises 7 wt % to 9 wt % hollow microspheres; 33 wt % to 35 wt % epoxy resin; and 1 wt % to 2 wt % dried sol-gel having a particle size, for instance, less than about 100 μm. In an additional embodiment, the epoxy syntactic foam composition can have a thermal conductivity less than 0.150 Watts/meter-° K, particularly less than 0.09 Watts/meter-° K, such as 0.01 Watts/meter-° K to 0.08 Watts/meter-° K.

In another embodiment, an insulated pipeline is provided comprising a hollow pipe having an outer surface, and an insulating layer that longitudinally encases (e.g. fully encases) the outer surface of the hollow pipe comprising a cured epoxy syntactic foam composition as disclosed herein. In various embodiments, the insulating layer can have an average thickness of about one inch or more, for instance, from about one to about six inches. The hollow pipe that is coated with the epoxy syntactic foam composition can have any outer diameter, inner diameter, and length, such as an outer diameter of at least 6 inches and a length of at least 10 feet. Other sizes below and above these ranges can be used. The pipe can have a cylindrical shape or other shape conducive to being coated with the curable epoxy syntactic foam composition.

In another embodiment, a method is provided for forming a thermal insulating layer on a pipe or pipeline comprising applying a composition on pipe, wherein the composition comprises curable epoxy resin, hollow microspheres, and dried sol-gel having a particle size, such as less than about 100 μm, and particularly further comprises a blowing agent for forming closed cells in the cured foam product. The composition can be applied to a pipe substrate as a mixture of the curable epoxy resin, hollow microspheres, dried sol-gel, and blowing agent. The technique used for applying the curable foam composition onto a pipe can be selected, for example, from coating, brushing, casting or extruding, and so forth, and particularly may be spray coating.

In other embodiment of the present invention, any of the embodiments described above and throughout can use one or more fumed metal oxides, such as fumed silica, in addition to or as an alternative to the dried sol-gel described herein.

It is to be understood that both the foregoing general description and the following detailed description are exemplary and explanatory only and are intended to provide a further explanation of the present invention, as claimed.

### BRIEF DESCRIPTION OF THE DRAWINGS

FIG. 1 is a perspective partially cut-away view of a segment of a pipe lined with an epoxy syntactic foam composition, according to an embodiment of the present invention.

FIG. 2 is a SEM photomicrograph of a cross-section of an epoxy syntactic foam composition which is representative of an embodiment of the present invention.

FIG. 3 is a plot of water uptake results at hydrostatic pressures of 200 psi and 0 psi applied over a period of time for an epoxy syntactic foam composition of an embodiment of the present invention.

FIG. 4 is a plot of water uptake results at hydrostatic pressures of 200 psi and 0 psi applied over an extended period of time for an epoxy syntactic foam composition of an embodiment of the present invention.

FIG. 5 is a plot of stress/strain properties of an epoxy syntactic foam composition of an embodiment of the present invention.

### DETAILED DESCRIPTION OF THE PRESENT INVENTION

The present invention relates to unique syntactic foams and thermal insulation materials. Particularly, the present invention relates to syntactic foams for thermal insulation of substrates such as oil pipelines in cold water, high hydrostatic pressure conditions.

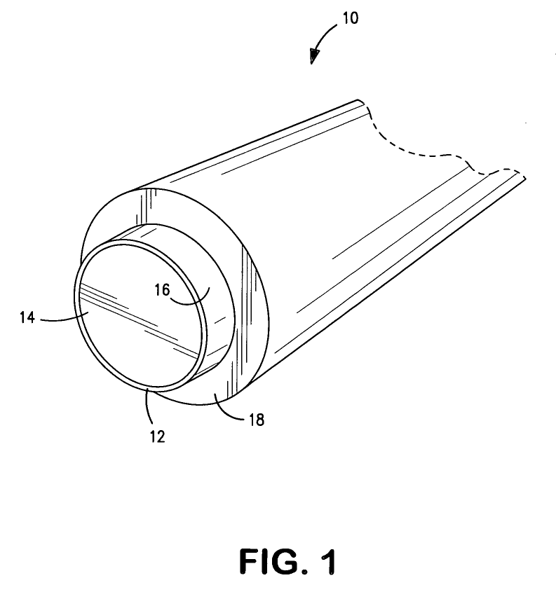

Referring to FIG. 1, an insulated pipe 10 includes a pipe 12 defining a passageway 14 or flow line for oil and/or gas, or other flowable material(s). The exterior surface 16 of the pipe 12 is coated with a lining 18 comprising an epoxy syntactic foam composition in accordance with various embodiments described herein. Although not shown, the insulated pipe 10 can be submerged underwater above, on, or below (buried in) the sea bed or ocean floor. For example, the lined pipe can be submerged in water or laid in a man-made trench formed on the sea bed. Fittings (not shown), such as collars, ells, tees, taps, and so forth, used in the pipeline also can be coated with the epoxy syntactic foam composition. The lined pipe 10 also can be used as a subcomponent of a pipe-in-pipe configuration. Also, although the epoxy syntactic foam composition is illustrated herein as a submerged underwater pipeline lining, it also can be used as a thermal insulative lining for pipes and conduits used in lines exposed to the air or ground, such as cold ambient air and cold or frozen ground environments. In one or more embodiments of the present invention, the present invention, using the composition of the present invention, can avoid the need for a pipe-in-pipe configuration. In other words, the use of the composition of the present invention permits sufficient thermal insulation such that a pipe-in-pipe configuration is not necessary. Of course, as an option, a pipe-in-pipe configuration can be used where the coating composition of the present invention is applied on one or more surfaces of any of the pipes present in a pipe-in-pipe configuration and/or on any layer that is present on a pipe in any pipe-in-pipe configuration. Further, in one or more embodiments of the present invention, the coating composition of the present invention can be applied to any surface of a pipe or any layer present on a pipe. Furthermore, more than one layer of the coating composition of the present invention can be present. In other words, the coating composition of the present invention can form two or more layers on a pipe or a layer present on a pipe. Further, other thermal insulating layers besides the composition of the present invention can be used in addition to the coating composition of the present invention, either in the same layer or as a separate layer.

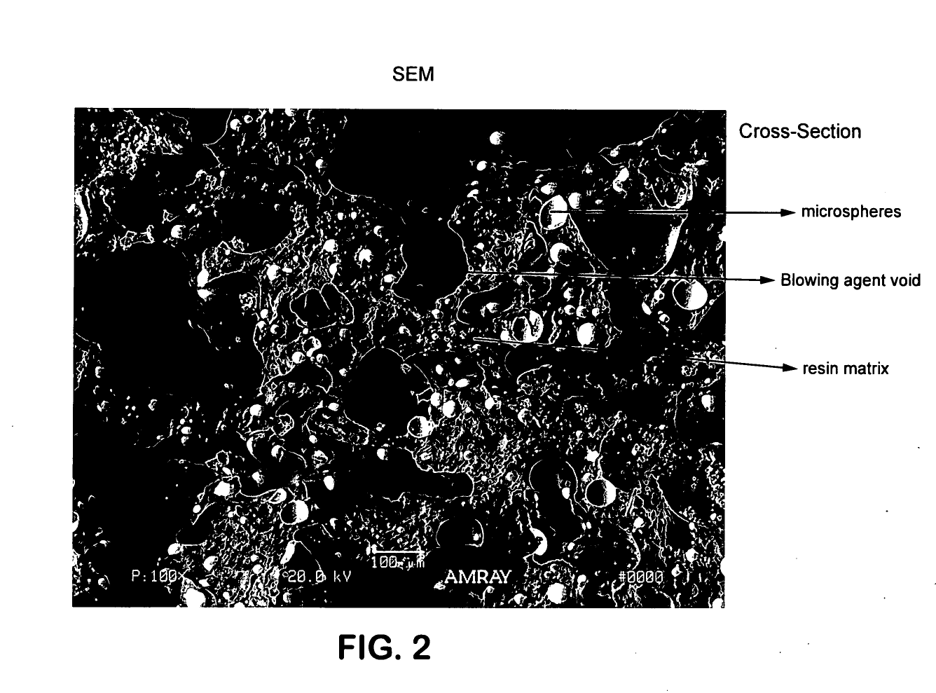

In various embodiments, the epoxy syntactic foam coating composition is prepared from a composition containing curable epoxy resin, hollow microspheres, and dried sol-gel having a particle size. The particle size can be less than about 100 μm, such as 1 μm to 99 μm, 10 μm to 75 μm, and the like. The particle sizes referred to in this application can be average particle sizes or can be D10, D50, or D90 numbers, or can be maximum size numbers. Referring to FIG. 2, in a further embodiment, the composition further optionally comprises a blowing agent that can form closed cells in the cured foam. As shown, microspheres are distributed throughout the resin matrix. No nanogel particles are visible in this figure.

In one embodiment, the cured epoxy syntactic foam composition comprises at least 25 vol % closed cell content. In a further embodiment, the cured epoxy syntactic foam composition comprises 5 vol % to 7 vol % hollow microspheres; 25 vol % to 31 vol % closed cell content; 20 vol % to 26 vol % epoxy resin; and 0.1 vol % to 7 vol % dried sol-gel having a particle size less than about 100 μm. In the same or another embodiment, the cured epoxy syntactic foam composition comprises 5 wt % to 8 wt % hollow microspheres; 27 wt % to 41 wt % epoxy resin; and 1 wt % to 5 wt % dried sol-gel. In an additional embodiment, the epoxy syntactic foam composition is formulated to have a thermal conductivity of less than 0.150 Watts/meter-° K, particularly less than 0.09 Watts/meter-° K such as 0.01 Watts/meter-° K to 0.08 Watts/meter-° K.

Syntactic epoxy foams made with these compositions have improved thermal insulation properties, buoyancy, controlled water uptake, and/or strength to withstand the hydrostatic pressure conditions at deep sea depths, such as in excess of several thousand feet of water (e.g. 2,000 to 10,000 ft. or more), and also provide a more rheologically coherent coating system that can be coated on a pipe surface and cured in place without sagging or unduly flowing before the composition sets. Therefore, the epoxy syntactic foam compositions of embodiments of the present invention provide excellent coating properties and behavior, and also end-product performance in deep sea conditions.

Amongst other surprising benefits and advantages, it has been discovered that the inclusion in the syntactic foam composition of dried sol-gel disperses well and helps bind the syntactic foam composition to provide a more coherent coating composition that adheres well and holds coating shape until it sets-up to significantly reduce or eliminate coating sagging problems without hampering the desired performance properties of the finished syntactic foam, such as when used in the field as thermal insulative lining for undersea pipes. Larger particle sizes of dried sol-gel particles do not impart the same advantageous rheological properties observed with the smaller sized particles (e.g. 100 μm or less).

In various embodiments, the dried sol-gel comprises amorphous aerogel particles, xerogel particles, or a combination of both. The dried sol-gel can have a particle size less than the wall size of the syntactic foam, and can be less than about 100 μm, particularly less than about 20 μm, more particularly less than about 10 μm. In one embodiment, the dried sol-gel has a particle size in the range of from 50 nm to 10 μm. The chemistry and the production of such materials derived from a dried sol-gel are well documented in the chemical literature, which discloses various methods for drying the dried sol-gel and for modifying its surface properties. The dried sol-gel suitable for the composition of the present invention include, but are not limited to, aerogel particles prepared by a process wherein the wet sol-gel is dried under supercritical pressure, and xerogel particles prepared by a process wherein the wet sol-gel is dried at a pressure below the supercritical pressure. Particles of amorphous silica aerogels or xerogels may be used, as well as particles of carbon aerogels or xerogels. The dried sol-gel can be porous. Generally, the dried sol-gel particles can have a porosity of from about 30% to 95% by volume. The porosity is a measure of the proportion of the volume of the particles that is taken up by air. The shape of the dried sol-gel particles is not particularly limited and includes irregular shapes as well as smooth and symmetrical shapes. The aerogels and xerogels suitable for use in the present invention may be prepared by methods known in the art, and are available from commercial suppliers, such as, for example, Cabot Corporation. As indicated, the syntactic foam composition can be formulated to provide from about 0.1 vol % to about 7 vol % dried sol-gel in the cured product. The sol-gel content is made sufficient to impart the improved coating properties (e.g., anti-sagging properties) in the curable syntactic foam composition. If the dried sol-gel content is too high, water uptake properties can be adversely impacted in the cured syntactic foam. Microspheres can optionally be present. The hollow microspheres reduce density and when used in the syntactic foam composition, increase the thermal insulative properties. The hollow microspheres, also referred to in the art as hollow microbubbles or microballoons, also can adjust the foam density, strength, and stiffness. Unless indicated otherwise herein, the term “microspheres” refers to hollow bodies and not solid bodies. The hollow microspheres are commercially available as small, generally spherical, hollow bodies available in a range of diameters of several hundred micrometers or less, with wall thicknesses typically less than several micrometers. The K37 glass bubbles from 3M that can be used, have an average wall thickness of 1.04 micrometers (15% glass, 85% void, density=0.37 g/cc). The average particle size of hollow microspheres which can be used in the present syntactic foam compositions lies within a range of from about 5 to about 150 microns, particularly from about 5 to about 110 microns. Omitting microspheres can increase density and/or sag. The density of these microspheres tends to vary from about 0.125 to 0.6 g/cc. The K37 material can have a particle size distribution (volume basis) of:

| | |
|---|---|
| 10^{th} % | 20 microns/v or less |
| 50^{th} % | 45 microns/v or less |
| 90^{th} % | 80 microns/v or less |
| 95^{th} % | 85 microns/v or less. |

The shells or walls of the hollow microspheres can be formed of glass, e.g., silica or borosilicates; ceramic, e.g., fly ash; or even polymers, such as phenolics. Glass microspheres are particularly useful as they tend to have lower thermal conductivity than ceramic microspheres. Glass microspheres are commercially available, for example, from Minnesota Mining & Manufacturing Co. (3M), St. Paul, Minn., such as K series microbubbles (e.g., K37 glass bubbles). Silica microballoons of this type are also available under the trademark Eccospheres from Trelleborg Emerson & Cuming, Inc., Randolph, Mass. The glass microspheres may be sodium-borosilicate based glass microspheres or other silica or silicate glass materials. As indicated, the syntactic foam composition can be formulated to provide from about 5 vol % to about 7 vol % hollow microspheres in the cured product. Sufficient microspheres are included in the foam formulation to adjust and control the thermal conductivity properties of the finished liner coating to desired levels. Excessive proportions of microspheres may lead to an inadequate polymer matrix, decreased elongation, and/or decreased water resistance. Large volume fraction of microspheres results in processing issues. The epoxy-sphere mix is preferably mildly treated to reduce or eliminate sphere breakage. This breakage and a high degree of it can have a negative impact on the thermal conductivity of the composite.

The curable epoxy resin forms a matrix in which the other components of the foam formulation are dispersed and fixed in place in the cured resin composition. In one embodiment, the curable epoxy resin generally comprises a basic epoxy and a hardening agent. The basic epoxy is a compound including at least one epoxide (oxirane) group. The hardener may be, for example, an amine curative or an anhydride curative, or a combination thereof. In one embodiment, a two part epoxy/amine matrix resin forming system is used. In this respect, a diepoxy-diamine matrix can be used in one embodiment. The epoxy resin can be commercially obtained, for example, as EPN 1179, obtained from Huntsman Corporation, and the amine hardener can be, for example, DEH 58, obtained from Dow Chemical. As indicated, the syntactic foam composition can be formulated to provide about 20 vol % to about 40 vol % epoxy resin in the cured product. The epoxy resin is selected and used in a sufficient amount to provide adequate wetting and adhesion to the microspheres and dried sol-gel at the curing temperatures to assure good mechanical properties and provide a polymeric matrix in the cured product sufficient to sustain a unitary composite material. The epoxy resins generally provide superior durability in undersea applications as compared to some other curable resins, such as typical polyurethanes.

Although the matrix resin is exemplified as epoxy resin herein, which is more highly suited for deep sea applications, it is not necessarily limited thereto. Depending on the particular air, water or ground conditions in which the pipe is used, suitable resins can include thermoset and thermoplastic resins and may be readily selected by those skilled in the art, usually dependent in at least part on the desired application. Illustrative examples include thermosets such as not only epoxy, but also polyester, polyurethane, polyurea, silicone, polysulfide, and phenolic resins and thermoplastics such as polyolefins (e.g., polypropylene, polyethylene, fluorinated polyolefins, polyamide, polyamide-imide, polyether-imide, polyether ketone resins, or blends of two or more such resins). The resin may be elastomeric or not as desired.

Blowing agents in one embodiment can be included in the curable syntactic foam composition to form closed voids in the cured syntactic foam products. The blowing agent can be a physical blowing agent and/or a chemical blowing agent introduced into the syntactic foam composition. Blowing agents include, for example, hydrocarbons such as isopentane, pentane, hexane, cyclopentane and cyclohexane, and halocarbons such as methylene chloride, or combinations thereof. The blowing agent is provided in a sufficient amount in the curable syntactic foam composition to induce a 5 vol % to 40 vol % closed cell content in the finished foam.

If desired and compatible, other additives might be incorporated in the curable syntactic foam compositions as desired, e.g., silicone foaming agent, solvents, epoxy diluent, fillers, surfactants, rheology modifiers, extenders, preservatives, algaecides, mixing agents, colorants, dispersants, wetting agents, water scavengers, singly or in any combinations thereof.

The pipe material useful as a substrate for receiving the epoxy syntactic foam composition is not particularly limited. Unless indicated otherwise herein, the term “pipe” is a general term encompassing any elongated hollow body having a passageway through which fluids can be conducted. The selection of pipe material will depend on the application. The pipe may be metal (e.g., steel, copper, aluminum), composite (e.g., fiber-reinforced resin), ceramic, polymeric (e.g., thermosetting resin, thermoplastic, elastomeric), and the like. For undersea pipelines, steel pipes are often used. Other substrates can also be coated with the epoxy syntactic foam composition. Lengths of pipe to be used for undersea applications can be welded together at their ends or connected by other means, such as adhesives, chemical welding, mechanical connections, and the like. The joints can be covered with an insulating material which can include the epoxy syntactic foam composition.

The coating thickness may vary, depending on the application. In various embodiments, the insulating layer can have an average thickness of one inch or greater (2.5 cm), and can be from about one to about six inches (about 2.5 to 15.2 cm). In general, the amount of insulation provided to a lined pipe by the syntactic foam composition is a positive function of the thickness of the foam material encased on the pipe. The material and process costs also will tend to increase with increased foam thickness. For oil and gas pipeline lining applications, the hollow pipe that is coated with the epoxy syntactic foam composition may have an outer diameter of at least 6 inches and a length of at least 10 feet, although these parameters can vary. The pipe can have a cylindrical shape or other shape conducive to being coated with the curable epoxy syntactic foam composition. The syntactic foam compositions of the present invention adhere well to rounded exterior surfaces such as cylindrical pipes without adversely sagging before they set up. Sag can be measured using procedure in ASTM D2202-88 (Standard Test Method for Slump of Sealants).

Some illustrative examples of syntactic foam manufacturing processes that may be adapted for formulating the syntactic foam compositions used in the present invention include batch processing, cast curing, meter mixing, reaction injection molding, continuous solids dispersion mixing, centrifugal planetary mixing which are known to be used for thermoset formulations, and compounding extrusion, and injection molding which are known to be used for thermoplastic formulations. According to the invention, the microspheres should be added to the resin system and mixed gently under sufficiently low shear conditions to reduce fracture of the microspheres. For instance, the liquids can be pre-mixed together. The sol-gel can be injected into the liquid first, below the surface using equipment like that which is available from Quadro. Then, the glass bubbles can be injected last, below the surface. The previously described shear conditions can be followed. The syntactic foam should be kept in a warm room (about 110° F.) before using to facilitate handling. Suitable techniques and processes for incorporating selected dried sol-gel and hollow microspheres as described above into the resin to form the desired syntactic foam compositions include those such as exemplified in the examples herein.

The curable syntactic foam composition can be applied to a substrate by conventional methods, such as by brush, roller, spraying, extrusion and casting, and the like. The syntactic composition may be applied directly to the substrate, or on top of a primer coat which is first applied to the substrate. An optional primer can be used, for example, Spray Foam Primer. An overcoat layer may optionally be applied on top of the lining layer of the syntactic foam composition, such as Spray Foam Sealer.

At the time of coating under ambient conditions of approximately 70-90° F., the syntactic composition of the invention generally can have a Brookfield viscosity of no more than about 35,000 centipoise, particularly from about 7,900 to 35,000 centipoise. Therefore, the composition can be sprayed and otherwise handled in the same manner as a conventional coating composition. When sprayed, the pipe and spray applicator or other coating dispensers are translated relative to one another so that a length of pipe can be coated in a generally continuous manner. Spray applicator systems that may be used in this respect for continuously coating the exterior surface of a pipe include, for example, AirTech Spray Systems. The coating may be applied at a substantially uniform thickness along the pipe, or can be varied in thickness if desired. Multiple and different coats of the same or different formulations of the epoxy syntactic foam composition also can be applied to a pipe surface.

In one or more embodiments, the curable epoxy syntactic foam composition of the present invention can serve as a void filler. As a void filler, the epoxy syntactic foam composition of the present invention can be cured prior to it being used as a void filler or cured after the epoxy syntactic foam composition is applied to the void to be filled. Further, the epoxy syntactic foam composition of the present invention, which can be a void filler, can be shaped into any desirable shape that would be suitable for void filling, such as strips, blocks, other geometrical objects, amorphous objects, irregular shapes, peanut shapes, and the like. The void filler can be applied in a non-cured state to a void to be filled, such as a void in a wall, such as a foundation, in a floor, in a well, in a pipe, on a surface of a pipe or other structure having one or more voids that need to be filled. The epoxy syntactic foam composition of the present invention can be applied as mentioned above in the other embodiments and can be applied such that it covers or fills or covers and fills the void and then subsequently is cured. The void filler can be applied as a coating or liquid composition to the void or voids to be filled, or can be pre-shaped, cured, and applied as cured void-filling objects to the void to be filled. If cured ahead of time to be an object to be used for void filling, the shapes and sizes can be any conventional void-filling shapes and sizes useful and will be dependent on the size of the void to be filled.

In one or more embodiments of the present invention, and as a substitute for the sol-gel or in addition to the sol-gel, a fumed metal oxide, such as a fumed silica, can be used in any one of the embodiments described herein. Thus, in one or more embodiments, the present invention relates to a curable epoxy syntactic foam coating composition for forming a thermal insulating material which can contain a curable epoxy resin, hollow microspheres, and a fumed metal oxide, such as a fumed silica, which can have particle sizes less than 100 microns and other sizes are possible. The curable epoxy syntactic foam coating composition can optionally contain one or more blowing agents, as well as other ingredients as set forth above. In addition, the curable epoxy syntactic foam coating composition can contain a dried sol-gel as described above. The present invention further relates to a cured epoxy syntactic foam composition containing the hardened epoxy resin, hollow microspheres, the fumed metal oxide, and closed gas-filled cells. The various characteristics, uses, embodiments, and parameters of the curable and/or cured epoxy syntactic foam composition described earlier with respect to the sol-gel embodiments can be adapted equally to the fumed metal oxide embodiments as well. The present invention further relates to an insulated pipeline comprising a hollow pipe having an outer surface and an insulating layer that encases the outer surface of the hollow pipe, wherein the insulating layer comprises the cured epoxy foam composition described herein. Further, the present invention relates to forming a thermal insulating layer on a pipeline or other substrate using one or more compositions of the present invention. Further, as explained above, the curable epoxy foam composition containing the fumed metal oxide can be used as a void filler, as well.

The present invention will be further clarified by the following examples, which are intended to be purely exemplary of the present invention. Unless otherwise indicated, all parts, percentages, ratios, etc., in the examples and the rest of the specification are in terms of weight.

### EXAMPLES

### Example 1

Conductivity and hydrostatic pressure tests were conducted on samples of epoxy syntactic foams having compositions which were representative of embodiments of the present invention.

An epoxy syntactic foam composition, which had the formulation indicated in Table 1, was prepared and formed into a 5 inch×5 inch×1.5 inch block shape and also coated on a 6 inch long 15 inch O.D. pipe to simulate field conditions. In order to conserve material, the pipe was coated by hand application.

The epoxy diluent was provided as Araldite RD2, obtained from Huntsman Corporation; the organo modified clay was provided as Garamite 1958, obtained from Southern Clay Products; the epoxy was provided as EPN 1179, obtained from Huntsman Corporation; the special epoxy diluent was provided as Nevoxy EPX-L, obtained from Neville Chemical; the silicone foaming agent was provided as DC-193, obtained from Dow Chemical; the dried sol-gel powder was provided as Nanogel TLD201, obtained from Cabot Corporation; the methyl acetate was used as a blowing agent; the glass bubbles were K37 Scotchlite™ glass bubbles, having a thermal conductivity reported as 124 mW/m, obtained from 3M, St. Paul, Minn.; the amine was provided as DEH 58, obtained from Dow Chemical; the nonylphenol was a diluent solvent; and cyclopentane was a blowing agent.

The formulation was batched as a two-part composition in the following manner. Five gallon open head pails were used for both the epoxy component side and for the amine component side. The pails were sealed with lids with gaskets. Prior to use the epoxy component side pail was opened and poured into 5 gallon spray machine tank. The lid was put back on and sealed. The tank was pressurized with compressed air. The same procedure was repeated with the amine component side. An air stirrer was turned on in the epoxy side to facilitate pumping and lower viscosity (thixatropic). The epoxy side tank was preheated to 150° F. and hose lines were preheated to 155° F. The epoxy and amine were sprayed through an airless sprayer at a volume ratio of approximately 2.1-2.3 parts by volume epoxy side to 1.0 part by volume amine side by volume.

TABLE 1
Epoxy Syntactic Foam Formulation.

| | | | | Vol (cc)/100 g |
|---|---|---|---|---|
| Component | Wt % | Vol % | Density, g/cc | of initial mix |
| Epoxy diluent | 15.20 | 10.38 | 1.1 | 13.82 |
| Organo modified | 4.61 | 2.16 | 1.3 | 3.55 |
| clay | | | | |
| Epoxy | 32.04 | 20.05 | 1.14 | 28.11 |
| Special epoxy | 13.10 | 9.55 | 1.03 | 12.72 |
| diluent | | | | |
| Silicone foaming | 0.92 | 0.65 | 1.07 | 0.86 |
| agent | | | | |
| Nanogel powder | 0.97 | 7.70 | 2.2 | 0.42 |
| Methyl acetate | 1.34 | 8.39 | 0.93 | 1.44 |
| Glass bubbles | 2.57 | 5.21 | 0.37 | 6.95 |
| Subtotals | 70.75 | 64.09 | | 67.87 |
| Amine | 9.04 | 6.78 | 0.99 | 9.13 |
| Nonylphenol | 6.37 | 5.06 | 0.937 | 6.80 |
| Accelerator | 4.21 | 3.29 | 0.96 | 4.39 |
| Organomodified clay | 0.30 | 0.14 | 1.3 | 0.23 |
| Nanogel powder | 0.49 | 3.89 | 2.2 | 0.22 |
| Glass bubbles | 7.70 | 15.60 | 0.37 | 20.81 |
| Cyclopentane | 1.15 | 1.16 | 0.747 | 1.54 |
| SubTotals | 29.95 | 37.31 | | 43.12 |
| Air | | | | 47.00 |
| Totals | 100 | 100 | 0.63 | 157.99 |

Based on the components added in the formulation mix (column 2), and their density (column 4) the volume/100 g of initial mixture is calculated (column 5). Measuring the density of the final foam, allows the calculation of the volume of “air” (cells created and filled by the blowing agent). From this the vol % of “air” (cells created by the blowing agent), glass microspheres and the rest of the system were calculated.

TABLE 2
Calculated volume fraction and component thermal conductivity

| Component | Vol % | K (mW/m-K) |
|---|---|---|
| Air | 29.7 | 26 |
| Glass Bubbles | 17.6 | 124 |
| Rest | 52.7 | 190 |

The dried sol-gel of small particle size were expected to be completely wetted, acting as a thixotropic agent and did not contribute directly to decrease the thermal conductivity. The calculated theoretical conductivity was about 117 mW/m-K, and the sample desirably would withstand hydrostatic conditions. The measured conductivity was 98.5 mW/m-K. The lower value can be attributed to the non-smooth surface of the test specimen and a lower thermal conductivity of cyclopentane filled cells compared to the assumed air filled cells.

TABLE 3
Water Pickup Tests.

| Test Sample | |
|---|---|
| | Pipe |
| Pipe Weight | 509.58 g |
| Dry Weight | 631.6 g |
| Wet Wt 2 hr soak in water | 640.2 g |
| Wet 100 psi 2 hr | 660 g |
| Weight of Insulation | 122.02 g |
| % water (gig) pickup at ambient | 7.0 |
| % water (g/g) pickup at 100 psi | 23.3 |
| Wet 100 psi 30 min | 4.4 |
| % water (v/v) pickup at 100 psi | 14.7 |
| % air pores (v/v) filled | 49.3 |
| | Block |
| Dry weight | 373 g |
| Wet Weight 2 hr soak in water | 380 g |
| Wet 100 psi 30 min | 427 g |
| Weight of insulation | 373 g |
| % water (g/g) pickup at ambient | 1.9 |
| % water (g/g) pickup at 100 psi | 14.5 |
| (v/v) pickup at ambient | 1.2 |
| % water (v/v) pickup at 100 psi | 9.1 |
| % air pores (v/v) filled | 30.7 |

As indicated by the results in Table 3, water uptake under ambient pressure was remarkably improved compared to previous formulations. At 100 psi of hydrostatic pressure, the water uptake was ˜15% (v/v) for the pipe and ˜9% (v/v) for the block. This water uptake is a pseudo-equilibrium value and represents the lower bound for the water uptake under service conditions. One can postulate that the presence of glass microspheres presents a boundary for the foamed cells, causing them to close, thereby improving the ambient pressure water uptake from 20% (v/v) to <2% for the block. Degradation in performance at higher pressures then represents the breakage of cells walls and the resulting infiltration of water.

### Example 2

Another epoxy syntactic foam composition, which had the formulation indicated in Table 4, was also prepared, which exhibited conductivity and hydrostatic pressure properties that were qualitatively comparable to the results seen for the formulation of Example 1.

TABLE 4

| Component | Wt % | Vol % | Density, g/cc | Vol (cc) |
|---|---|---|---|---|
| Epoxy diluent | 15.47 | 11.91 | 1.1 | 13.4 |
| Organo modified | 4.69 | 2.48 | 1.3 | 3.4 |
| clay | | | | |
| Epoxy | 32.6 | 23.01 | 1.14 | 27.2 |
| Special epoxy | 13.33 | 10.96 | 1.03 | 12.3 |
| diluent | | | | |
| Silicone-glycol | 1.04 | 0.82 | 1.05 | 0.9 |
| copolymer | | | | |
| Nanogel powder | 1.03 | 9.21 | 2.2 | 0.4 |
| Glass bubbles | 2.61 | 5.96 | 0.37 | 6.7 |
| Subtotals | 70.77 | 64.35 | | 64.45 |
| Polyamine hardener | 7.84 | 6.78 | 1 | 7.5 |
| Amine | 5.75 | 4.87 | 0.99 | 5.5 |
| Nonylphenol | 3.92 | 3.51 | 0.937 | 4.0 |
| Accelerator | 4.28 | 3.78 | 0.96 | 4.2 |
| Organomodified clay | 0.92 | 0.49 | 1.3 | 0.7 |
| Nanogel powder | 0.5 | 4.47 | 2.2 | 0.2 |
| Glass bubbles | 4.57 | 10.44 | 0.37 | 11.8 |
| Cyclopentane | 0.78 | 0.88 | 0.747 | 1.0 |
| Methyl acetate | 0.68 | 0.42 | 0.93 | 0.7 |
| SubTotals | 29.24 | 35.64 | | 35.55 |
| Air | | | | 56.5 |
| Totals | 100 | 100 | 0.63 | 161.6 |

In Table 4, the nonhydrolyzable silicone-glycol copolymer was provided as Rhodorsil SP-3301, obtained from Rhodia; and the polyamine hardener was provided as Aradur 837, obtained from Huntsman Advanced Materials; and the other components were similar to those described for Table 1.

Table of Calculations.

| | Vol % | K |
|---|---|---|
| Volume % air | 35.0 | 26 mW/m-K |
| Volume % K37 | 7.6 | 124 mW/m-K |
| Rest volume % | 57.4 | 190 mW/m-K |
| Calculated Thermal Conductivity | 115 mW/m-K | |
| Observed Thermal Conductivity | 77.0 mW/m-K | |

### Example 3

Another epoxy syntactic foam composition, which had a formulation similar to that indicated in Table 1 was also prepared, for which water uptake and stress/strain mechanical properties were measured.

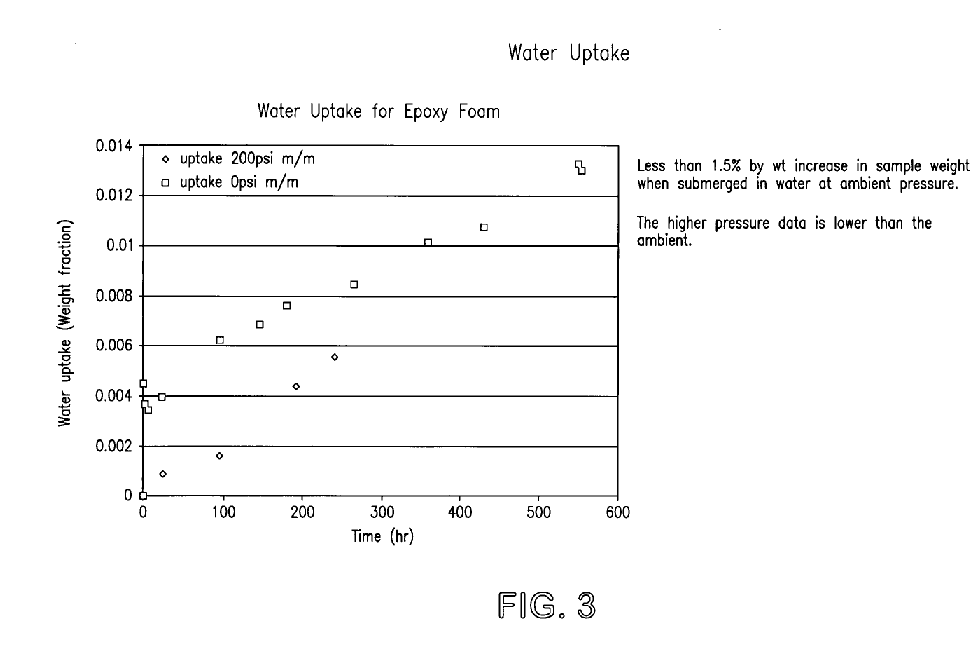

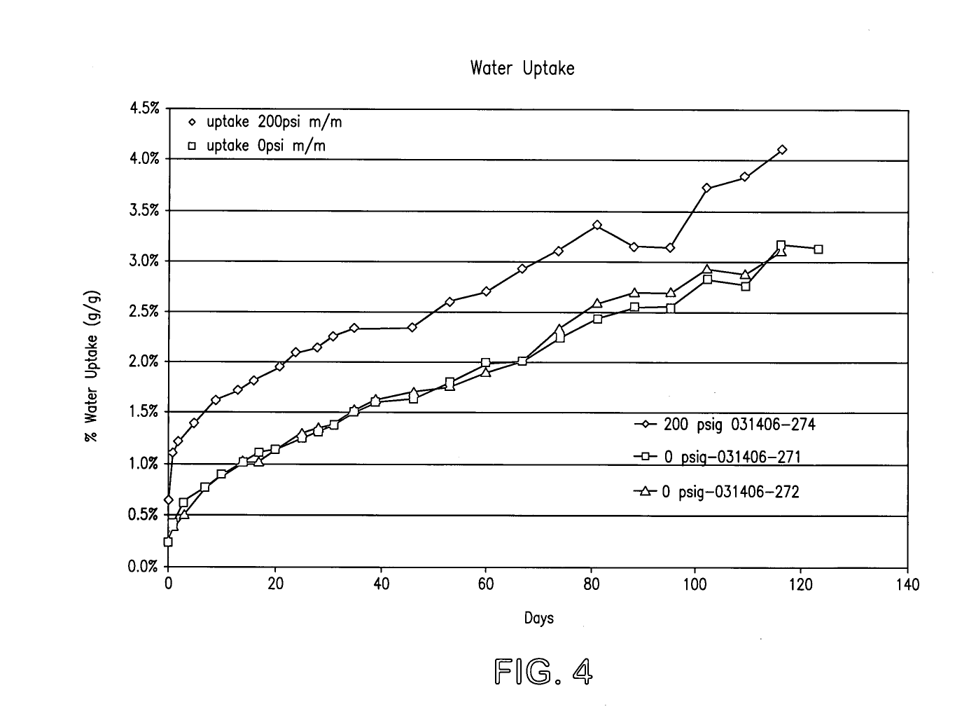

FIG. 3 is a plot of water uptake results at hydrostatic pressures of 200 psi and 0 psi applied over a period of time for an epoxy syntactic foam composition of an embodiment of the present invention. FIG. 4 is a plot of water uptake results at hydrostatic pressures of 200 psi and 0 psi applied over an extended period of time for an epoxy syntactic foam composition of an embodiment of the present invention. The results in these figures show water uptake to be a little faster at 0 psi initially then at 200 psi.

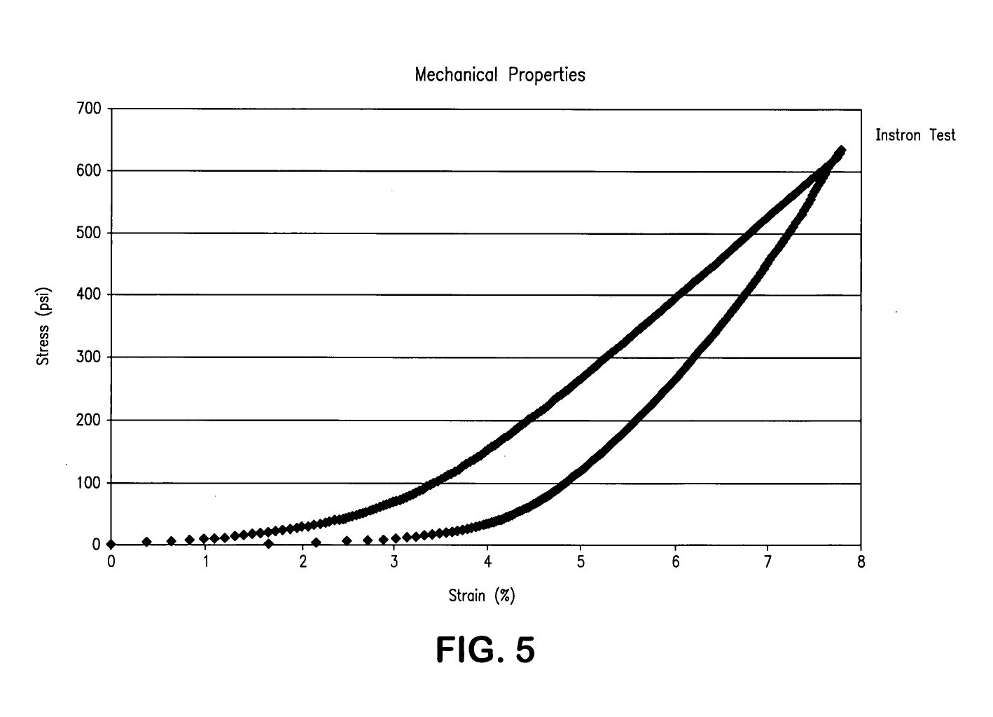

FIG. 5 is a plot of stress/strain properties of an epoxy syntactic foam composition of an embodiment of the present invention. The results in this figure show good compressive modulus.

### Example 4

In this example, several epoxy compositions were formed, which had the formulations set forth in Table 5 or Table 6 with the indicated weight percents. In one formulation, a nanogel powder was used (formulation set forth in Table 5), and in the other formulation, a fumed silica powder (CabOSil) was used. The formulations were prepared in the same manner as in Example 1. From each formulation, various sizes of molded epoxy blocks were formed and these molded epoxy blocks were then subjected to water absorption tests to determine the percent by weight water absorbed over a 70-day period, wherein the blocks were measured throughout the 70-day period to determine the percent of water absorbed. The amount of water absorbed was low (less than 20 wt % water absorbed) especially for Sample C in each formulation (less than 4 wt % water absorbed), which was a 2-inch×2-inch×¾-inch molded epoxy block. The example shows that the formulations containing the fumed silica powder or the nanogel powder, provided sufficient resistance to water absorption such that curable epoxy coating compositions can be formed for a variety of uses including thermal insulation and for other uses as set forth in the present application.

TABLE 5

| Component | Wt % |
|---|---|
| Epoxy diluent | 16.22 |
| Organo | 4.92 |
| modified | |
| Clay | |
| Epoxy | 34.20 |
| Special epoxy | 13.97 |
| Diluent | |
| Silicone- | 1.09 |
| glycol | |
| Copolymer | |
| Nanogel | 1.08 |
| powder | |
| Glass bubbles | 2.74 |
| Subtotals | 74.22 |
| Polyamine | 8.22 |
| hardener | |
| Nonylphenol | 4.10 |
| Accelerator | 2.25 |
| Organomodified | 0.96 |
| clay | |
| Nanogel | 0.52 |
| powder | |
| Glass bubbles | 2.16 |
| Amine | 6.03 |
| Methyl acetate | 0.72 |
| Cyclopentane | 0.82 |
| Subtotals | 25.78 |
| Totals | 100.00 |

TABLE 6

| Component | Wt % |
|---|---|
| Epoxy diluent | 16.22 |
| Organo | 4.92 |
| modified | |
| Clay | |
| Epoxy | 34.20 |
| Special epoxy | 13.97 |
| diluent | |
| Silicone- | 1.09 |
| glycol | |
| Copolymer | |
| Cabosil HS-5 | 1.08 |
| Glass bubbles | 2.74 |
| Subtotals | 74.22 |
| Polyamine | 8.22 |
| hardener | |
| Nonylphenol | 4.10 |
| Accelerator | 2.25 |
| Organomodified | 0.96 |
| clay | |
| Cabosil HS-5 | 0.52 |
| Glass bubbles | 2.16 |
| Amine | 6.03 |
| Methyl acetate | 0.72 |
| Cyclopentane | 0.82 |
| Subtotals | 25.78 |
| Totals | 100.00 |

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A curable epoxy syntactic foam coating composition for forming a thermal insulating material, wherein the composition comprises:
a) curable epoxy resin;
b) hollow microspheres; and
c) dried sol-gel or fumed metal oxide having a particle size less than about 100 μm.

2. The composition of claim 1, further comprising a blowing agent.

3. The composition of claim 1, wherein said dried sol-gel is aerogel particles or xerogel particles, or a combination thereof.

4. The composition of claim 1, wherein said particles are amorphous silica aerogel particles.

5. The composition of claim 1, wherein said dried sol-gel has a particle size of less than about 20 μm.

6. The composition of claim 1, wherein said dried sol-gel has a particle size of less than about 10 μm.

7. The composition of claim 1, wherein said dried sol-gel has a particle size in the range of from 50 nm to 10 μm.

8. A cured epoxy syntactic foam composition comprising:
a) hardened epoxy resin;
b) hollow microspheres;
c) dried sol-gel or fumed metal oxide having a particle size less than about 100 μm; and
d) closed gas-filled cells.

9. The cured epoxy syntactic foam composition of claim 8, comprising at least 25 vol % closed cell content.

10. The cured epoxy syntactic foam composition of claim 8, comprising 5 vol % to 7 vol % hollow microspheres; 25 vol % to 30 vol % closed cell content; 20 vol % to 31 vol % epoxy resin; and 0.1 vol % to 7 vol % dried sol-gel having a particle size less than about 100 μm.

11. The cured epoxy syntactic foam composition of claim 8, wherein said syntactic foam composition has a thermal conductivity less than 0.150 watts/meter-° K.

12. The cured epoxy syntactic foam composition of claim 8, wherein said dried sol-gel is aerogel particles or xerogel particles, or a combination thereof.

13. The cured epoxy syntactic foam composition of claim 8, wherein said particles are amorphous silica aerogel particles.

14. The cured epoxy syntactic foam composition of claim 8, wherein said dried sol-gel has a particle size of less than about 20 μm.

15. The cured epoxy syntactic foam composition of claim 8, wherein said dried sol-gel has a particle size of less than about 10 μm.

16. The cured epoxy syntactic foam composition of claim 8, wherein said dried sol-gel has a particle size in the range of from 50 nm to 10 μm.

17. An insulated pipeline, comprising:
a hollow pipe having an outer surface; and
an insulating layer that longitudinally encases said outer surface of said hollow pipe, wherein said insulating layer comprises a cured epoxy syntactic foam composition comprising hardened epoxy resin; hollow microspheres; dried sol-gel or fumed metal oxide having a particle size less than about 100 μm; and closed gas-filled cells.

18. The insulated pipeline of claim 17, wherein said insulating layer has an average thickness greater than one inch.

19. The insulated pipeline of claim 17, wherein said insulating layer has an average thickness of about one inch to about six inches.

20. The insulating pipe of claim 17, wherein the hollow pipe has an outer diameter of at least 6 inches and a length of at least 10 feet.

21. The insulating pipe of claim 17, wherein the hollow pipe comprises a cylindrical shape.

22. A method for forming a thermal insulating layer on a pipeline comprising applying the composition of claim 1 on pipe.

23. The method of claim 22, wherein said composition further comprises a blowing agent.

24. The method of claim 22, wherein said composition is applied as a homogenous mixture of the curable epoxy resin, hollow microspheres, dried sol-gel, and blowing agent.

25. The method of claim 22, wherein said applying is by coating, casting or extruding.

26. A method of filling voids in an article having at least one void, comprising filling at least a portion of said void with the curable epoxy syntactic foam coating composition of claim 1.
